(19) United States
(12) Patent Application Publication
(10) Pub. No.: US 2022/0259527 A1
(43) Pub. Date: Aug. 18, 2022

(54) ADHERENT COMPOSITION FOR RNA VIRUSES AND METHOD OF REMOVING RNA VIRUSES FROM A SURFACE

(71) Applicant: KIMBERLY-CLARK WORLDWIDE, INC., Neenah, WI (US)

(72) Inventors: Kathleen C. Engelbrecht, Kaukauna, WI (US); Stacy A. Mundschau, Weyauwega, WI (US); David W. Koenig, Menasha, WI (US); Scott W. Wenzel, Neenah, WI (US)

(21) Appl. No.: 17/737,549

(22) Filed: May 5, 2022

Related U.S. Application Data
(62) Division of application No. 16/071,343, filed on Jul. 19, 2018.

(51) Int. Cl. C11D 17/04; C11D 7/26; C11D 7/32

(52) U.S. Cl. CPC C11D 17/049; C11D 7/32; C11D 7/26

(57) ABSTRACT

A composition for increasing the adherence of RNA viruses can include a liquid carrier, an adherent agent, and a humectant. The adherent agent can be water soluble or dispersible polyester, Methylcellulose, Polyvinylpyrrolidone, and combinations thereof. The composition can be non-antimicrobial. A method for removing RNA viruses from a surface can include providing a composition for increasing the adherence of RNA viruses, applying the composition to the surface, and removing at least some of the composition from the surface to remove RNA viruses from the surface.

### TECHNICAL FIELD

Disclosed is a composition with adherent properties. More specifically, disclosed is a composition that includes an adherent agent that increases the adherence of RNA viruses to a surface. The composition may be applied to or incorporated into articles such as wipes, or into ointments, lotions, creams, salves, aerosols, gels, suspensions, sprays, foams, washes, or the like.

### BACKGROUND OF THE DISCLOSURE

Communicable human infections pass from person to person through various means such as food, aerosols, surfaces and hands. For example, in the United States, foodborne pathogens alone cause an estimated 76 million cases of illness, 325,000 hospitalizations and 5,000 deaths per year. This results in the spending or loss of several billion dollars due to absenteeism, cost of medication, and hospitalization.

Foodborne pathogens are typically a result of poor cleaning of hands and surfaces on which food is prepared. In fact, the kitchen is one of the most contaminated sites in the home. High fecal and coliform concentrations can be found in sponges, dishcloths, and the kitchen sink. Of course, there are other pathogens lurking elsewhere in the home, at the office, and in public places such as public bathrooms, restaurants, malls, theaters, health-care facilities, etc. Such pathogens include bacteria, protein, active enzymes, viruses, and many other microbes that can lead to health problems. RNA viruses, including influenza, noroviruses, rhinoviruses, polio virus, and enteroviruses, are common causes of diseases in humans. These viruses can lead to symptoms of vomiting, diarrhea, body aches, and fevers, among others. RNA viruses, like other pathogens, can be commonly spread by shaking hands with infected people or touching a surface or object with RNA viruses on it.

There are products used today that are used to clean skin and hard surfaces where pathogens such as RNA viruses may be deposited, such as soaps, hand sanitizers, sprays and wipes. Existing products, either in the form of chemical solutions or wipes incorporated with a chemical solution, often deliver the chemicals to a contaminated surface in an antimicrobial format to rid pathogens, and if in wipe form, may try to remove these pathogens. However, there is a concern of increasing resistance of pathogens to common antimicrobial treatments. Additionally, even if the common solutions are effective, pathogens may exist on the surface after application of the wipe impregnated with the chemical solution or after the chemical solution is wiped from the surface to which it was applied. It is desirable to have a composition or a wipe including a composition that has enhanced retaining properties of the pathogens without necessarily being antimicrobial.

There remains a need for compositions that can be applied to surfaces or incorporated into articles, wherein the compositions increase the adherence of RNA viruses. Desirably, the compositions are skin friendly, cost effective, and convenient to use.

### SUMMARY OF THE DISCLOSURE

In one aspect of the disclosure, a composition for increasing the adherence of RNA viruses can include a liquid carrier, an adherent agent, and a humectant. The anti-adherent agent can be selected from the group consisting of: water soluble or dispersible polyester, Methylcellulose, Polyvinylpyrrolidone, and combinations thereof. The composition can be non-antimicrobial.

In another aspect of the disclosure, a method for removing RNA viruses from a surface can include providing a composition for increasing the adherence of RNA viruses. The composition can include an adherent agent selected from the group consisting of water soluble or dispersible polyester, Methylcellulose, Polyvinylpyrrolidone, and combinations thereof. The composition can be non-antimicrobial. The method can further include applying the composition to the surface. The method can also include removing at least some of the composition from the surface to remove RNA viruses from the surface.

In still another aspect of the disclosure, a wipe can include a nonwoven substrate and a composition for increasing the adherence of RNA viruses. The composition can include a liquid carrier and an adherent agent. The adherent agent can be selected from the group consisting of: water soluble or dispersible polyester, Methylcellulose, Polyvinylpyrrolidone, and combinations thereof. The composition can be non-antimicrobial.

### DETAILED DESCRIPTION OF THE DISCLOSURE

The present disclosure is directed to an adherent composition containing an adherent agent and a carrier that increases the adherence of RNA viruses and a method of removing RNA viruses from a surface. The composition may be applied to a surface in the form of a liquid, gel, or foam; or incorporated into a wash. In addition, the composition may be applied to a surface with a vehicle such as a wipe.

The adherent composition may be used on biotic surfaces such as skin or plants; or abiotic surfaces such as food prep surfaces; hospital and clinic surfaces; household surfaces; automotive, train, ship and aircraft surfaces; and the like; as long as the surface is compatible with the ingredients of the composition.

Importantly, some embodiments of the adherent composition of the present disclosure are not antimicrobial. In other words, in some embodiments the adherent composition does not include any antimicrobial agents. In such embodiments, the adherent composition seeks to prevent attachment of RNA viruses to a surface, not eradicate the RNA viruses and any other microbes. This distinction can provide a benefit for the effectiveness for preventing the further spreading of RNA viruses as concerns grow about the increasing microbial resistance to common antimicrobial treatments. However, in some embodiments, as will be discussed further below, it is contemplated that the adherent composition can include antimicrobial agents.

According to the High Throughput Test to Quantify the Attachment of Phage to a Surface (discussed further below), the adherent composition increases adherence of DNA viruses to a surface by at least −0.15 Log, by at least −0.20 Log, by at least −0.25 Log, by at least −0.35 Log, by at least −0.40 Log, by at least −0.45 Log, by at least −0.50 Log, by at least −0.60, or by at least −0.70 Log.

### Adherent Agents

The adherent agents suitable for use in the adherent composition may include but not be limited to: polyesters, Methylcellulose, Polyvinylpyrrolidone, and combinations thereof. Polyesters can be manufactured by polymerizing organic acids and alcohols. Of particular interest are polyesters that are water soluble or dispersible. One example of a polyester that is suitable as an adherent agent is Polyester-5. Polyester-5 is a synthetic polymer commercially available under the name Eastman AQ available from Eastman Chemical Co. Methylcellulose is a modified cellulose that is commercially available under the name Benecel A4c by Ashland Inc. The methylcellulose may have a molecular weight of about 1,000 Daltons to about 500,000 Daltons, or about 10,000 Daltons to about 100,000 Daltons, or about 20,000 Daltons to about 50,000 Daltons. Polyvinylpyrrolidone (PVP) is a synthetic polymer that is commercially available under the name Flexithix from Ashland Inc.

As show in the High Throughput Test to Quantify the Attachment of Phage to a Surface (as discussed further below), Polyester-5, Methylcellulose, Polyvinylpyrrolidone were the only agents of many different agents tested that provided the unique result of increasing the adherence of RNA viruses to a surface but providing a reduction in adherence of bacteria to a surface. Most of the agents that provided a reduction in adherence to bacteria provided a reduction in adherence of RNA viruses as well, as expected. Additionally, most of the agents that inhibited the adherence of bacteria, also inhibited the adherence of DNA viruses. Thus, the adherent effect of Polyester-5, Methylcellulose, Polyvinylpyrrolidone against RNA viruses provided a surprising result.

Some embodiments of the adherent compositions of the present disclosure can be suitably made with an adherent agent in an amount of from about 0.01% (by the total weight of the composition) to about 20% (by total weight of the composition), or preferably from about 0.05% (by total weight of the composition) to about 15% (by total weight of the composition), or more preferably from about 0.1% (by total weight of the composition) to about 10% (by total weight of the composition). In one preferred embodiment, the adherent composition included about 1.0% of Polyester-5 (by total weight of the composition). In another preferred embodiment, the adherent composition included about 5.0% of Methylcellulose (by total weight of the composition. In yet another preferred embodiment, the adherent composition included about 5.0% of Polyvinylpyrrolidone (by total weight of the composition).

### Carriers

The adherent compositions of the present disclosure may be formulated with one or more conventional and compatible carrier materials. The adherent composition may take a variety of forms including, without limitation, aqueous solutions, gels, balms, lotions, suspensions, creams, milks, salves, ointments, sprays, emulsions, oils, resins, foams, solid sticks, aerosols, and the like. Liquid carrier materials suitable for use in the instant disclosure include those well-known for use in the cosmetic and medical arts as a basis for ointments, lotions, creams, salves, aerosols, gels, suspensions, sprays, foams, washes, and the like, and may be used in their established levels.

Non-limiting examples of suitable carrier materials include water, emollients, humectants, polyols, surfactants, esters, perflurocarbons, silicones, and other pharmaceutically acceptable carrier materials. In one embodiment, the carrier is volatile, allowing for immediate deposition of the adherent ingredient to the desired surface while improving overall usage experience of the product by reducing drying time. Non-limiting examples of these volatile carriers include 5 cst Dimethicone, Cyclomethicone, Methyl Perfluoroisobutyl Ether, Methyl Perfluorobutyl Ether, Ethyl Perfluoroisobutyl Ether and Ethyl Perfluorobutyl Ether. Unlike conventional volatile carriers such as ethanol or isopropyl alcohol, these carriers have no antimicrobial effect.

In one embodiment, the adherent compositions can optionally include one or more emollients, which typically act to soften, soothe, and otherwise lubricate and/or moisturize the skin. Suitable emollients that can be incorporated into the compositions include oils such as alkyl dimethicones, alkyl methicones, alkyldimethicone copolyols, phenyl silicones, alkyl trimethylsilanes, dimethicone, dimethicone crosspolymers, cyclomethicone, lanolin and its derivatives, fatty esters, glycerol esters and derivatives, propylene glycol esters and derivatives, alkoxylated carboxylic acids, alkoxylated alcohols, fatty alcohols, and combinations thereof.

The adherent compositions may include one or more emollients in an amount of from about 0.01% (by total weight of the composition) to about 20% (by total weight of the composition), or from about 0.05% (by total weight of the composition) to about 10% (by total weight of the composition), or from about 0.10% (by total weight of the composition) to about 5% (by total weight of the composition).

In another embodiment the adherent compositions include one or more esters. The esters may be selected from cetyl palmitate, stearyl palmitate, cetyl stearate, isopropyl laurate, isopropyl myristate, isopropyl palmitate, and combinations thereof. The fatty alcohols include octyldodecanol, lauryl, myristyl, cetyl, stearyl, behenyl alcohol, and combinations thereof. Ethers such as eucalyptol, ceteraryl glucoside, dimethyl isosorbic polyglyceryl-3 cetyl ether, polyglyceryl-3 decyltetradecanol, propylene glycol myristyl ether, and combinations thereof can also suitably be used as emollients. Other suitable ester compounds for use in the adherent compositions or the present disclosure are listed in the International Cosmetic Ingredient Dictionary and Handbook, 11th Edition, CTFA, (January, 2006) ISBN-10: 1882621360, ISBN-13: 978-1882621361, and in the 2007 Cosmetic Bench Reference, Allured Pub. Corporation (Jul. 15, 2007) ISBN-10: 1932633278, ISBN-13: 978-1932633276, both of which are incorporated by reference herein to the extent they are consistent herewith.

Humectants that are suitable as carriers in the adherent compositions of the present disclosure include, for example, glycerin, glycerin derivatives, hyaluronic acid, hyaluronic acid derivatives, betaine, betaine derivatives amino acids, amino acid derivatives, glycosaminoglycans, glycols, polyols, sugars, sugar alcohols, hydrogenated starch hydrolysates, hydroxy acids, hydroxy acid derivatives, salts of PCA and the like, and combinations thereof. Specific examples of suitable humectants include honey, sorbitol, hyaluronic acid, sodium hyaluronate, betaine, lactic acid, citric acid, sodium citrate, glycolic acid, sodium glycolate, sodium lactate, urea, propylene glycol, butylene glycol, pentylene glycol, ethoxydiglycol, methyl gluceth-10, methyl gluceth-20, polyethylene glycols (as listed in the International Cosmetic Ingredient Dictionary and Handbook such as PEG-2 through PEG 10), propanediol, xylitol, maltitol, or combinations thereof. Humectants are beneficial in that they prevent or reduce the chance that the adherent film, formed after the adherent agent is applied to a surface, will crack.

The adherent compositions of the disclosure may include one or more humectants in an amount of about 0.01% (by total weight of the composition) to about 20% (by total weight of the composition), or about 0.05% (by total weight of the composition) to about 10% by total weight of the composition), or about 0.1% (by total weight of the composition) to about 5.0% (by total weight of the composition).

The adherent compositions may include water. For instance, where the adherent composition is a wetting composition, such as described below for use with a wet wipe, the composition will typically include water. The adherent compositions can suitably comprise water in an amount of from about 0.01% (by total weight of the composition) to about 99.98% (by total weight of the composition), or from about 1.00% (by total weight of the composition) to about 99.98% (by total weight of the composition), or from about 50.00% (by total weight of the composition) to about 99.98% (by total weight of the composition), or from about 75.00% (by total weight of the composition) to about 99.98% (by total weight of the composition).

In an embodiment where the adherent composition serves as a wash (e.g. shampoo; surface cleaner; or hand, face, or body wash), the adherent composition will include one or more surfactants. These may be selected from anionic, cationic, nonionic, zwitterionic, and amphoteric surfactants. Amounts may range from 0.1 to 30%, or from 1 to 20%, or from 3 to 15% by total weight of the composition.

Suitable anionic surfactants include, but are not limited to, C₈ to C₂₂ alkane sulfates, ether sulfates and sulfonates. Among the suitable sulfonates are primary C₈ to C₂₂ alkane sulfonate, primary C₈ to C₂₂ alkane disulfonate, C₈ to C₂₂ alkene sulfonate, C₈ to C₂₂ hydroxyalkane sulfonate or alkyl glyceryl ether sulfonate. Specific examples of anionic surfactants include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium laureth sulfate, sodium lauryl sarcosinate, sodium lauroyl sarcosinate, potassium lauryl sulfate, sodium trideceth sulfate, sodium methyl lauroyl taurate, sodium lauroyl isethionate, sodium laureth sulfosuccinate, sodium lauroyl sulfosuccinate, sodium tridecyl benzene sulfonate, sodium dodecyl benzene sulfonate, sodium lauryl amphoacetate and mixtures thereof. Other anionic surfactants include the C₈ to C₂₂ acyl glycinate salts. Suitable glycinate salts include sodium cocoylglycinate, potassium cocoylglycinate, sodium lauroylglycinate, potassium lauroylglycinate, sodium myristoylglycinate, potassium myristoylglycinate, sodium palmitoylglycinate, potassium palmitoylglycinate, sodium stearoylglycinate, potassium stearoylglycinate, ammonium cocoylglycinate and mixtures thereof. Cationic counter-ions to form the salt of the glycinate may be selected from sodium, potassium, ammonium, alkanolammonium and mixtures of these cations.

Suitable cationic surfactants include, but are not limited to alkyl dimethylamines, alkyl amidopropylamines, alkyl imidazoline derivatives, quaternised amine ethoxylates, and quaternary ammonium compounds.

Suitable nonionic surfactants include, but are not limited to, alcohols, acids, amides or alkyl phenols reacted with alkylene oxides, especially ethylene oxide either alone or with propylene oxide. Specific nonionics are C₆ to C₂₂ alkyl phenols-ethylene oxide condensates, the condensation products of C₈ to C₁₃ aliphatic primary or secondary linear or branched alcohols with ethylene oxide, and products made by condensation of ethylene oxide with the reaction products of propylene oxide and ethylenediamine. Other nonionics include long chain tertiary amine oxides, long chain tertiary phosphine oxides and dialkyl sulphoxides, alkyl polysaccharides, amine oxides, block copolymers, castor oil ethoxylates, ceto-oleyl alcohol ethoxylates, ceto-stearyl alcohol ethoxylates, decyl alcohol ethoxylates, dinonyl phenol ethoxylates, dodecyl phenol ethoxylates, end-capped ethoxylates, ether amine derivatives, ethoxylated alkanolamides, ethylene glycol esters, fatty acid alkanolamides, fatty alcohol alkoxylates, lauryl alcohol ethoxylates, mono-branched alcohol ethoxylates, natural alcohol ethoxylates, nonyl phenol ethoxylates, octyl phenol ethoxylates, oleyl amine ethoxylates, random copolymer alkoxylates, sorbitan ester ethoxylates, stearic acid ethoxylates, stearyl amine ethoxylates, synthetic alcohol ethoxylates, tall oil fatty acid ethoxylates, tallow amine ethoxylates and trid tridecanol ethoxylates.

Suitable zwitterionic surfactants include, for example, alkyl amine oxides, silicone amine oxides, and combinations thereof. Specific examples of suitable zwitterionic surfactants include, for example, 4-[N,N-di(2-hydroxyethyl)-N-octadecylammonio]-butane-1-carboxylate, S—[S-3-hydroxypropyl-S-hexadecylsulfonio]-3-hydroxypentane-1-sulfate, 3-[P,P-diethyl-P-3,6,9-trioxatetradexopcylphosphonio]-2-hydroxypropane-1-phosphate, 3-[N,N-dipropyl-N-3-dodecoxy-2-hydroxypropylammonio]-propane-1-phosphonate, 3-(N,N-dimethyl-N-hexadecylammonio)propane-1-sulfonate, 3-(N,N-dimethyl-N-hexadecylammonio)-2-hydroxypropane-1-sulfonate, 4-[N,N-di(2-hydroxyethyl)-N-(2-hydroxydodecyl)ammonio]-butane-1-carboxylate, 3-[S-ethyl-S-(3-dodecoxy-2-hydroxypropyl)sulfonio]-propane-1-phosphate, 3-[P,P-dimethyl-P-dodecylphosphonio]-propane-1-phosphonate, 5-[N,N-di(3-hydroxypropyl)-N-hexadecylammonio]-2-hydroxy-pentane-1-sulfate, and combinations thereof.

Suitable amphoteric surfactants include, but are not limited to, derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one substituent contains an anionic group, e.g., carboxy, sulfonate, sulfate, phosphate, or phosphonate. Illustrative amphoterics are coco dimethyl carboxymethyl betaine, cocoamidopropyl betaine, cocobetaine, oleyl betaine, cetyl dimethyl carboxymethyl betaine, lauryl bis-(2-hydroxyethyl) carboxymethyl betaine, stearyl bis-(2-hydroxypropyl) carboxymethyl betaine, oleyl dimethyl gamma-carboxypropyl betaine, lauryl bis-(2-hydroxypropyl)alpha-carboxyethyl betaine, cocoamphoacetates, and combinations thereof. The sulfobetaines may include stearyl dimethyl sulfopropyl betaine, lauryl dimethyl sulfoethyl betaine, lauryl bis-(2-hydroxyethyl) sulfopropyl betaine and combinations thereof.

### Rheology Modifier

Optionally, one or more rheology modifiers, such as thickeners, may be added to the adherent compositions. Suitable rheology modifiers are compatible with the adherent agent. As used herein, “compatible” refers to a compound that, when mixed with the adherent agent, does not adversely affect the adherent properties of same.

A thickening system is used in the adherent compositions to adjust the viscosity and stability of the compositions. Specifically, thickening systems prevent the composition from running off of the hands or body during dispensing and use of the composition. When the adherent composition is used with a wipe product, a thicker formulation can be used to prevent the composition from migrating from the wipe substrate.

The thickening system should be compatible with the compounds used in the present disclosure; that is, the thickening system, when used in combination with the adherent compounds, should not precipitate out, form a coacervate, or prevent a user from perceiving the conditioning benefit (or other desired benefit) to be gained from the composition. The thickening system may include a thickener which can provide both the thickening effect desired from the thickening system and a conditioning effect to the user's skin.

Thickeners may include, cellulosics, gums, acrylates, starches and various polymers. Suitable examples include are not limited to hydroxethyl cellulose, xanthan gum, guar gum, potato starch, and corn starch. In some embodiments, PEG-150 stearate, PEG-150 distearate, PEG-175 diisostearate, polyglyceryl-10 behenate/eicosadioate, disteareth-100 IPDI, polyacrylamidomethylpropane sulfonic acid, butylated PVP, and combinations thereof may be suitable.

While the viscosity of the compositions will typically depend on the thickener used and the other components of the compositions, the thickeners of the compositions suitably provide for a composition having a viscosity in the range of greater than 10 cP to about 30,000 cP or more. In another embodiment, the thickeners provide compositions having a viscosity of from about 100 cP to about 20,000 cP. In yet another embodiment thickeners provide compositions having a viscosity of from about 200 cP to about 15,000 cP.

Typically, the adherent compositions of the present disclosure include the thickening system in an amount of no more than about 20% (by total weight of the composition), or from about 0.01% (by total weight of the composition) to about 20% (by total weight of the composition). In another aspect the thickening system is present in the adherent composition in an amount of from about 0.10% (by total weight of the composition) to about 10% (by total weight of the composition), or from about 0.25% (by total weight of the composition) to about 5% (by total weight of the composition), or from about 0.5% (by total weight of the composition) to about 2% (by total weight of the composition).

### Foaming Agents

In one embodiment, the adherent compositions are delivered as a foam. In accordance with the present disclosure, in order to make the composition foamable, the composition is combined with a foaming agent such as at least one derivatized dimethicone.

The foaming agent is capable of causing the compositions to foam when the compositions are combined with air using, for instance, a manual pump dispenser. Although the adherent compositions may be dispensed from an aerosol container, an aerosol is not needed in order to cause the compositions to foam. Also of particular advantage, the compositions are foamable without having to include fluorinated surfactants.

Various different derivatized dimethicone foaming agents may be used in the compositions of the present disclosure. The derivatized dimethicone, for instance, may comprise a dimethicone copolyol, such as an ethoxylated dimethicone. In one embodiment, the derivatized dimethicone is linear, although branched dimethicones may be used.

The amount of foaming agent present in the foaming compositions can depend upon various factors and the desired result. In general, the foaming agent can be present in an amount from about 0.01% to about 10% by weight, or from about 0.1% to about 5% by weight, or from about 0.1% to about 2% by weight.

When an adherent composition is made foamable, it may be contained in an aerosol container. In an aerosol container, the composition is maintained under pressure sufficient to cause foam formation when dispensed.

### Emulsifiers

In one embodiment, the adherent compositions may include hydrophobic and hydrophilic ingredients, such as a lotion or cream. Generally, these emulsions have a dispersed phase and a continuous phase, and are generally formed with the addition of a surfactant or a combination of surfactants with varying hydrophilic/lipopiliclipophilic balances (HLB). Suitable emulsifiers include surfactants having HLB values from 0 to 20, or from 2 to 18. Suitable non-limiting examples include Ceteareth-20, Cetearyl Glucoside, Ceteth-10, Ceteth-2, Ceteth-20, Cocamide MEA, Glyceryl Laurate, Glyceryl Stearate, PEG-100 Stearate, Glyceryl Stearate, Glyceryl Stearate SE, Glycol Distearate, Glycol Stearate, Isosteareth-20, Laureth-23, Laureth-4, Lecithin, Methyl Glucose Sesquistearate, Oleth-10, Oleth-2, Oleth-20, PEG-100 Stearate, PEG-20 Almond Glycerides, PEG-20 Methyl Glucose Sesquistearate, PEG-25 Hydrogenated Castor Oil, PEG-30 Dipolyhydroxystearate, PEG-4 Dilaurate, PEG-40 Sorbitan Peroleate, PEG-60 Almond Glycerides, PEG-7 Olivate, PEG-7 Glyceryl Cocoate, PEG-8 Dioleate, PEG-8 Laurate, PEG-8 Oleate, PEG-80 Sorbitan Laurate, Polysorbate 20, Polysorbate 60, Polysorbate 80, Polysorbate 85, Propylene Glycol Isostearate, Sorbitan Isostearate, Sorbitan Laurate, Sorbitan Monostearate, Sorbitan Oleate, Sorbitan Sesquioleate, Sorbitan Stearate, Sorbitan Trioleate, Stearamide MEA, Steareth-100, Steareth-2, Steareth-20, Steareth-21. The compositions can further include surfactants or combinations of surfactants that create liquid crystalline networks or liposomal networks. Suitable non-limiting examples include OLIVEM 1000 (INCI: Cetearyl Olivate (and) Sorbitan Olivate (available from HallStar Company (Chicago, Ill.)); ARLACEL LC (INCI: Sorbitan Stearate (and) Sorbityl Laurate, commercially available from Croda (Edison, N.J.)); CRYSTALCAST MM (INCI: Beta Sitosterol (and) Sucrose Stearate (and) Sucrose Distearate (and) Cetyl Alcohol (and) Stearyl Alcohol, commercially available from MMP Inc. (South Plainfield, N.J.)); UNIOX CRISTAL (INCI: Cetearyl Alcohol (and) Polysorbate 60 (and) Cetearyl Glucoside, commercially available from Chemyunion (Sao Paulo, Brazil)). Other suitable emulsifiers include lecithin, hydrogenated lecithin, lysolecithin, phosphatidylcholine, phospholipids, and combinations thereof.

### Adjunct Ingredients

The adherent compositions of the present disclosure may additionally include adjunct ingredients conventionally found in pharmaceutical compositions in an established fashion and at established levels. For example, the adherent compositions may comprise additional compatible pharmaceutically active and compatible materials for combination therapy, such as antioxidants, anti-parasitic agents, antipruritics, antifungals, antiseptic actives, biological actives, astringents, keratolytic actives, local anaesthetics, anti-stinging agents, anti-reddening agents, skin soothing agents, external analgesics, film formers, skin exfoliating agents, sunscreens, and combinations thereof.

Other suitable additives that may be included in the adherent compositions of the present disclosure include compatible colorants, deodorants, emulsifiers, anti-foaming agents (when foam is not desired), lubricants, skin conditioning agents, skin protectants and skin benefit agents (e.g., aloe vera and tocopheryl acetate), solvents, solubilizing agents, suspending agents, wetting agents, pH adjusting ingredients (a suitable pH range of the compositions can be from about 3.5 to about 8), chelators, propellants, dyes and/or pigments, and combinations thereof.

Another component that may be suitable for addition to the adherent compositions is a fragrance. Any compatible fragrance may be used. Typically, the fragrance is present in an amount from about 0% (by weight of the composition) to about 5% (by weight of the composition), and more typically from about 0.01% (by weight of the composition) to about 3% (by weight of the composition). In one desirable embodiment, the fragrance will have a clean, fresh and/or neutral scent to create an appealing delivery vehicle for the end consumer.

Organic sunscreens that may be present in the adherent compositions include ethylhexyl methoxycinnamate, avobenzone, octocrylene, benzophenone-4, phenylbenzimidazole sulfonic acid, homosalate, oxybenzone, benzophenone-3, ethylhexyl salicylate, and mixtures thereof.

In some embodiments, antimicrobial agents may be added to the adherent compositions. For example, suitable antimicrobials include biocides such as a short-chain alcohol, benzoalkonium chloride (“BAC”), didecyl dimethyl ammonium chloride (“DDAC”), and zeolite (“CWT-A”). Other possible antimicrobial agents include: isothiazolone, alkyl dimethyl ammonium chloride, a triazine, 2-thiocyanomethylthio benzothiazol, methylene bis thiocyanate, acrolein, dodecylguanidine hydrochloride, a chlorophenol, a quaternary ammonium salt, gluteraldehyde, a dithiocarbamate, 2-mercatobenzothiazole, para-chloro-meta-xylenol, silver, chlorohexidine, polyhexamthylene biguanide, a n-halamine, triclosan, a phospholipid, an alpha hydroxyl acid, 2,2-dibromo-3-nitrilopropionamide, 2-bromo-2-nitro-1,3-propanediol, farnesol, iodine, bromine, hydrogen peroxide, chlorine dioxide, a botanical oil, a botanical extract, benzalkonium chloride, chlorine, sodium hypochlorite, or combinations thereof. In some embodiments, the antimicrobial agent can be antibacterial. In some embodiments, the antimicrobial agent can be antiviral. In some embodiments, the antimicrobial agent can be antibacterial and antiviral.

When present, the amount of the antimicrobial agent in the adherent compositions is in an amount between about 0.01% to about 5% (by total weight of the composition), or in some embodiments between about 0.05% to about 3% (by total weight of the composition).

### Preservatives

The adherent compositions may include various preservatives to increase shelf life. Some suitable preservatives that may be used in the present disclosure include, but are not limited to phenoxyethanol, capryl glycol, glyceryl caprylate, sorbic acid, gallic acid, KATHON CG®, which is a mixture of methylchloroisothiazolinone and methylisothiazolinone, (available from Rohm & Haas Company, Philadelphia, Pa.); DMDM hydantoin (e.g., GLYDANT, available from Lonza, Inc., Fair Lawn, N.J.); EDTA and salts thereof; iodopropynyl butylcarbamate; benzoic esters (parabens), such as methylparaben, propylparaben, butylparaben, ethylparaben, isopropylparaben, isobutylparaben, benzylparaben, sodium methylparaben, and sodium propylparaben; 2-bromo-2-nitropropane-1,3-diol; benzoic acid; and the like. Other suitable preservatives include those sold by Sutton Labs Inc., Chatham, N.J., such as “GERMALL 115” (imidazolidinyl urea), “GERMALL II” (diazolidinyl urea), and “GERMALL PLUS” (diazolidinyl urea and iodopropynyl butylcarbonate).

The amount of the preservative in the adherent compositions is dependent on the relative amounts of other components present within the composition. For example, in some embodiments, the preservative is present in the compositions in an amount between about 0.001% to about 5% (by total weight of the composition), in some embodiments between about 0.01 to about 3% (by total weight of the composition), and in some embodiments, between about 0.05% to about 1.0% (by total weight of the composition).

### Preparation of Adherent Compositions

The adherent compositions of the present disclosure may be prepared by combining ingredients at room temperature and mixing.

In one embodiment, when the adherent composition is to be applied to the skin of an individual, the composition includes the adherent agent, a hydrophilic carrier and a hydrophilic thickener. Suitable hydrophilic carriers can be, for example, water, glycerin, glycerin derivatives, glycols, water-soluble emollients, and combinations thereof. Suitable examples of glycerin derivatives could include, but are not to be limited to, PEG-7 glyceryl cocoate. Suitable glycols could include, but are not to be limited to, propylene glycol, butylene glycol, pentylene glycol, ethoxydiglycol, dipropylene glycol, propanediol, and PEG-8. Suitable examples of water-soluble emollients could include, but are not to be limited to, PEG-6 Caprylic Capric Glycerides, Hydrolyzed Jojoba Esters, and PEG-10 Sunflower Glycerides.

### Delivery Vehicles

The adherent compositions of the present disclosure may be used in combination with a product. For example, the composition may be incorporated into or onto a substrate, such as a wipe substrate, an absorbent substrate, a fabric or cloth substrate, a tissue or paper towel substrate, or the like. In one embodiment, the adherent composition may be used in combination with a wipe substrate to form a wet wipe or may be a wetting composition for use in combination with a wipe which may be dispersible. In other embodiments, the adherent composition may be incorporated into wipes such as wet wipes, hand wipes, face wipes, cosmetic wipes, cloths and the like. In yet other embodiments, the adherent compositions described herein can be used in combination with numerous personal care products, such as absorbent articles. Absorbent articles of interest are diapers, training pants, adult incontinence products, feminine hygiene products, and the like; bath or facial tissue; and paper towels. Personal protective equipment articles of interest include but are not limited to masks, gowns, gloves, caps, and the like.

In one embodiment, the wet wipe may comprise a nonwoven material that is wetted with an aqueous solution termed the “wetting composition,” which may include or be composed entirely of the anti-adherent compositions disclosed herein. As used herein, the nonwoven material comprises a fibrous material or substrate, where the fibrous material or substrate comprises a sheet that has a structure of individual fibers or filaments randomly arranged in a mat-like fashion. Nonwoven materials may be made from a variety of processes including, but not limited to, airlaid processes, wet-laid processes such as with cellulosic-based tissues or towels, hydroentangling processes, staple fiber carding and bonding, melt blown, and solution spinning.

The fibers forming the fibrous material may be made from a variety of materials including natural fibers, synthetic fibers, and combinations thereof. The choice of fibers may depend upon, for example, the intended end use of the finished substrate and the fiber cost. For instance, suitable fibers may include, but are not limited to, natural fibers such as cotton, linen, jute, hemp, wool, wood pulp, etc. Similarly, suitable fibers may also include: regenerated cellulosic fibers, such as viscose rayon and cuprammonium rayon; modified cellulosic fibers, such as cellulose acetate; or synthetic fibers, such as those derived from polypropylenes, polyethylenes, polyolefins, polyesters, polyamides, polyacrylics, etc. Regenerated cellulose fibers, as briefly discussed above, include rayon in all its varieties as well as other fibers derived from viscose or chemically modified cellulose, including regenerated cellulose and solvent-spun cellulose, such as Lyocell. Among wood pulp fibers, any known papermaking fibers may be used, including softwood and hardwood fibers. Fibers, for example, may be chemically pulped or mechanically pulped, bleached or unbleached, virgin or recycled, high yield or low yield, and the like. Chemically treated natural cellulosic fibers may be used, such as mercerized pulps, chemically stiffened or crosslinked fibers, or sulfonated fibers.

In addition, cellulose produced by microbes and other cellulosic derivatives may be used. As used herein, the term “cellulosic” is meant to include any material having cellulose as a major constituent, and, specifically, comprising at least 50 percent by weight cellulose or a cellulose derivative. Thus, the term includes cotton, typical wood pulps, non-woody cellulosic fibers, cellulose acetate, cellulose triacetate, rayon, thermomechanical wood pulp, chemical wood pulp, debonded chemical wood pulp, milkweed, or bacterial cellulose. Blends of one or more of any of the previously described fibers may also be used, if so desired.

The fibrous material may be formed from a single layer or multiple layers. In the case of multiple layers, the layers are generally positioned in a juxtaposed or surface-to-surface relationship and all or a portion of the layers may be bound to adjacent layers. The fibrous material may also be formed from a plurality of separate fibrous materials wherein each of the separate fibrous materials may be formed from a different type of fiber.

Airlaid nonwoven fabrics are particularly well suited for use as wet wipes. The basis weights for airlaid nonwoven fabrics may range from about 20 to about 200 grams per square meter (gsm) with staple fibers having a denier of about 0.5 to about 10 and a length of about 6 to about 15 millimeters. Wet wipes may generally have a fiber density of about 0.025 g/cc to about 0.2 g/cc. Wet wipes may generally have a basis weight of about 20 gsm to about 150 gsm. More desirably the basis weight may be from about 30 to about 90 gsm. Even more desirably the basis weight may be from about 50 gsm to about 75 gsm.

Processes for producing airlaid non-woven basesheets are described in, for example, published U.S. Pat. App. No. 2006/0008621, herein incorporated by reference to the extent it is consistent herewith.

As shown by the examples and testing described further below, and specifically in Table 1, the use of the adherent agents of water soluble or dispersible polyesters (e.g., Polyester-5), Methylcellulose, or Polyvinylpyrrolidone provided an increase in the attachment of RNA viruses to a polystyrene surface by at least −0.35 Log of viruses according to the High Throughput Test to Quantify the Attachment of Phage to a Surface, discussed below. Specifically, the use the adherent agent of Methylcellulose provided an increase in the attachment of RNA viruses to a polystyrene surface by −0.73 Log of viruses according to the High Throughput Test to Quantify the Attachment of Phage to a Surface, the use of the adherent agent of Polyester-5 provided an increase in the attachment of RNA viruses to a polystyrene surface by at least −0.37 Log of viruses according to the High Throughput Test to Quantify the Attachment of Phage to a Surface, and the use of Polyvinylpyrrolidone provided an increase in the attachment of RNA viruses to a polystyrene surface by −0.43 Log of viruses according to the High Throughput Test to Quantify the Attachment of Phage to a Surface.

As will be discussed further below, these results are surprising from the standpoint that the compositions that included the agents of water soluble or dispersible polyester (e.g., Polyester-5), Methylcellulose, or Polyvinylpyrrolidone when tested against Gram negative bacteria (Escherichia coli) and Gram positive bacteria (Staphylococcus aureus) provided a decrease in adherence of each bacteria to a polystyrene surface, as noted in Table 4, as well as a decrease in adherence of DNA viruses to a polystyrene surface, as noted in Table 2. Additionally, these compositions including the adherent agents of water soluble or dispersible polyester (e.g., Polyester-5), Methylcellulose, or Polyvinylpyrrolidone provided unexpected results from the standpoint that various other compositions including agents that led to adherent properties to RNA viruses exhibited adherent properties against bacteria, and not anti-adherent properties against bacteria as did each of water soluble or dispersible polyester (e.g., Polyester-5), Methylcellulose, or Polyvinylpyrrolidone.

This dichotomy of properties of increasing adherence of RNA viruses but inhibiting the adherence of bacteria can provide a benefit in an embodiment where the compositions including the agents of water soluble or dispersible polyester (e.g., Polyester-5), Methylcellulose, or Polyvinylpyrrolidone are applied to a surface and then at least some of agent is removed from the surface, for example with a substrate. For example, compositions including one or more of the agents of water soluble or dispersible polyester (e.g., Polyester-5), Methylcellulose, or Polyvinylpyrrolidone can be applied to the surface by spraying a liquid or foam composition and then wiped off with a fibrous substrate. Alternatively, the compositions including one or more of the agents of water soluble or dispersible polyester (e.g., Polyester-5), Methylcellulose, or Polyvinylpyrrolidone could be incorporated into a wipe and the compositions could be applied to the surface by contacting the surface with the wipe. In either format, at least some of the composition including the adherent agents of water soluble or dispersible polyester (e.g., Polyester-5), Methylcellulose, or Polyvinylpyrrolidone can be removed from the surface, and in doing so, can provide the benefit that can help to remove RNA viruses from such a surface by adhering to the RNA viruses. Additionally, at least some of the composition including one or more of the agents of water soluble or dispersible polyester (e.g., Polyester-5), Methylcellulose, or Polyvinylpyrrolidone can remain on the surface, in which the anti-adherent properties against bacteria of water soluble or dispersible polyester (e.g., Polyester-5), Methylcellulose, or Polyvinylpyrrolidone can provide a decrease in adherence of bacteria to that surface. Thus, the agents of water soluble or dispersible polyester (e.g., Polyester-5), Methylcellulose, Polyvinylpyrrolidone can each help increase the adherence of RNA viruses to a substrate (e.g., a wipe) to help remove them from such a surface, but at the same time help reduce the adherence of Gram negative and Gram positive bacteria from adhering to that same surface. This is true whether the compositions including one or more of the agents of water soluble or dispersible polyester (e.g., Polyester-5), Methylcellulose, or Polyvinylpyrrolidone are applied to the surface as a liquid, gel, foam, etc. and then wiped off the surface with a substrate or whether the compositions including one or more of the agents of water soluble or dispersible polyester (e.g., Polyester-5), Methylcellulose, or Polyvinylpyrrolidone are incorporated into a substrate (e.g., a wetting composition in a wipe) and then applied to the surface.

The disclosure will be more fully understood upon consideration of the following non-limiting examples described in the following section on testing.

### Testing

Attachment Against RNA Viruses

The adherent compositions that increase the attachment of RNA viruses to a surface was discovered through testing a variety of compounds as adherent agents against RNA viruses via the High Throughput Test to Quantify the Attachment of Phage to a Surface. Table 1 below shows the variety of compounds that were tested as agents in a composition, as well as the results that related to the percent reduction in viruses, the Logarithmic Reduction compared to growth controls, the T-Test Value, and whether the Logarithmic Reduction was statistically significant (S for significant, NS for not significant). As will be discussed in further detail below, a positive logarithmic reduction in viruses equates to anti-adherent properties against RNA viruses (e.g., inhibits attachment), and a negative logarithmic reduction in viruses equates to adherent properties against RNA viruses (e.g., increases attachment).

As can be seen from Table 1, only four of the twenty-five compounds tested exhibited statistically significant negative logarithmic reductions in testing against RNA viruses, and thus, can help to increase adherence of an RNA virus to a surface. Those four compounds were: Polyester-5, Methylcellulose, Polyvinylpyrrolidone, and Methyl Hydroxyethyl Cellulose (MHEC). However, Methyl Hydroxyethyl Cellulose (MHEC) also provided a negative logarithmic reduction against Gram negative bacteria (Table 5) and DNA viruses (Table 2). Surprisingly, compounds Polyester-5, Methylcellulose, Polyvinylpyrrolidone were the only agents that increased adherence of an RNA virus to a surface, but also decreased adherence of bacteria to a surface. Looking specifically at the agent of Polyester-5, the logarithmic reduction in RNA viruses was −0.37, but this agent provided a logarithmic reduction of 1.39 for Gram negative bacteria and a logarithmic reduction of 1.08 for Gram positive bacteria (see Table 5). Methylcellulose provided a logarithmic reduction in RNA viruses of −0.73, but this agent provided a logarithmic reduction of 0.90 for Gram negative bacteria and a logarithmic reduction of 0.71 for Gram positive bacteria (see Table 5). Polyvinylpyrrolidone provided a logarithmic reduction in RNA viruses of −0.43, but this agent provided a logarithmic reduction of 0.61 for Gram negative bacteria and a logarithmic reduction of 0.59 for Gram positive bacteria (see Table 5). Thus, for compositions including the agents of Polyester-5, Methylcellulose, or Polyvinylpyrrolidone, the compositions increased adherence to RNA viruses, but also decreased adherence to both Gram negative and Gram positive bacteria. Furthermore, this result of adherent properties against RNA viruses for compositions including Polyester-5, Methylcellulose, or Polyvinylpyrrolidone is further surprising from the standpoint that when compositions including Polyester-5, Methylcellulose, or Polyvinylpyrrolidone were tested against DNA viruses (see Table 2), the compounds each decreased adherence of DNA viruses to a polystyrene surface.

The RNA virus that the compositions were tested against for attachment behaviors was MS2. Bacteriophage are commonly utilized as surrogates of mammalian viruses in both medical and virology applications. MS2 phage is commonly utilized as a viral surrogate because of its size, morphology, environmental stability, non-human infectivity, and the ability for use in high throughput assays. Additionally, MS2 is commonly used as a surrogate to study the spread of human Norovirus (See, Tung-Thompson, et al, PLoS One, 2015, 10(8): e0134277, Dawson D J, et al, J App Micro, 2005, 98: 203-209, Jones, et al, J Hosp Infect, 1991, 17:279-85). The use of MS2 phage in hand sanitizer studies makes it an ideal surrogate to study the interaction of personal care products and viral attachment. It is believed that compositions including the adherent agents noted above would act in a substantially similar behavior to other RNA viruses as they did against MS2.

TABLE 1
Compounds and corresponding Log Reduction of DNA virus using the High
Throughput Test to Quantify the Attachment of Phage to a Surface

| | | | | | | Log R | | |
|---|---|---|---|---|---|---|---|---|
| | | | | | | (PFU/mL) | | |
| | | Compound | Con. | | | compared | | Statistical |
| | Compound | Name | Wt. | | Percent | to growth | T-Test | Signif. |
| # | Type | (Manufacturer) | %* | INCI Name | Reduction | controls | Value | e(p < 0.05) |
| 1 | Modified | Sigma HPMC | 3 | Hydroxypropyl | 26.35% | 0.13 | 0.32 | NS |
| | cellulose | (Sigma Aldrich) | | methylcellulose | | | | |
| 2 | Modified | Benecel A4c | 1 | Methylcellulose | −438.40% | −0.73 | 0.01 | S |
| | cellulose | (Ashland Inc.) | | | | | | |
| 3 | Modified | Benecel E15 | 1 | Hydroxypropyl- | 80.17% | 0.70 | 0.02 | S |
| | cellulose | (Ashland Inc.) | | cellulose | | | | |
| 4 | Modified | Natrosol LR | 1 | Hydroxyethyl- | 80.20% | 0.70 | 0.01 | S |
| | cellulose | (Ashland Inc.) | | cellulose | | | | |
| 5 | Polysaccharide | Structure Cel | 3 | Methyl | −1391.29% | −1.17 | 0 | S |
| | | 8000 | | Hydroxyethyl | | | | |
| | | (AkzoNobel) | | Cellulose (MHEC) | | | | |
| 6 | Polysaccharide | Structure Cel | 1.5 | C₁₂₋₁₆ Alkyl PEG-2 | −51.65% | −0.18 | 0.27 | NS |
| | | 500 | | Hydroxypropyl | | | | |
| | | (AkzoNobel) | | Hydroxyethyl | | | | |
| | | | | Ethylcellulose | | | | |
| 7 | Polymeric | Aristoflex Velvet | 0.4 | Polyacrylate | 99.01% | 2.00 | 0 | S |
| | sulfonic acid, | (Clariant) | | Crosspolymer-11 | | | | |
| | neutralized | | | | | | | |
| 8 | Hydrophobically | Aculyn 22 | 2 | Acrylates/Steareth- | 20.14% | 0.10 | 0.21 | NS |
| | modified | (Dow Chemicals) | | 20 Methacrylate | | | | |
| | acrylate | | | Copolymer | | | | |
| 9 | Synthetic | Eastman AQ | 5 | Polyester-5 | −133.58% | −0.37 | 0 | S |
| | polymer | (Eastman | | | | | | |
| | | Chemical Co.) | | | | | | |
| 10 | Synthetic | Pluronic 62 | 5 | Ethylene | 99.17% | 2.08 | 0 | S |
| | polymer | (BASF | | Oxide/Propylene | | | | |
| | | Corporation) | | Oxide Block | | | | |
| | | | | Copolymer | | | | |
| 11 | Modified | Arlasilk PLN | 5 | Linoleamidopropyl | 95.08% | 1.31 | 0 | S |
| | silicone | (Croda, Inc.) | | PG-Dimonium | | | | |
| | | | | Chloride | | | | |
| | | | | Phosphate | | | | |
| | | | | Dimethicone | | | | |
| 12 | Hydrophobically | Aculyn 38 | 2 | Acrylates/Vinyl | −37.97% | −0.14 | 0.25 | NS |
| | modified | (Dow Chemicals) | | Neodecanoate | | | | |
| | acrylate | | | Crosspolymer | | | | |
| 13 | anionic | SESAFLASH | 5 | Glycerin⁺, | 91.27% | 1.06 | 0 | S |
| | polymeric | (Seppic) | | Acrylates | | | | |
| | emulsifier | | | Copolymer, | | | | |
| | | | | VP/Polycarbamyl | | | | |
| | | | | Polyglycol Ester, | | | | |
| | | | | Hydrolyzed | | | | |
| | | | | Sesame Protein | | | | |
| | | | | PG-Propyl | | | | |
| | | | | Methylsilanediol⁺ | | | | |
| 14 | Synthetic | Pecogel GC-310 | 5 | VP/Dimethylamino | 82.37% | 0.75 | 0 | S |
| | polymer | (Phoenix | | ethylmethacrylate/ | | | | |
| | | Chemicals) | | Polycarbamyl | | | | |
| | | | | Polyglycol Ester | | | | |
| 15 | Silicone | DC 193 Fluid | 6 | PEG-12 | 95.99% | 1.40 | 0 | S |
| | | (Dow Chemicals) | | Dimethicone | | | | |
| 16 | Synthetic | Sepimax ZEN | 0.4 | Polyacrylate | 78.58% | 0.67 | 0 | S |
| | polymer | (Fairfield) | | Crosspolymer-6 | | | | |
| 17 | Synthetic | Ultrez 10 | 0.4 | Carbomer | 79.17% | 0.68 | 0 | S |
| | polymer | (Lubrizol | | | | | | |
| | | Corporation) | | | | | | |
| 18 | Silicone | Dow Corning | 100 | Dimethicone | 96.88% | 1.51 | 0 | S |
| | | 200 (100 cst) | | | | | | |
| | | (Dow Corning) | | | | | | |
| 19 | Polysaccharide | Protanal Ester | 4 | Propylene Glycol | 83.69% | 0.79 | 0 | S |
| | | BV 3750 | | Alginate | | | | |
| 20 | Modified | Polyderm PPI- | 5 | Bis-PEG-15 | 93.24% | 1.17 | 0 | S |
| | silicone | SI-WS (Alzo) | | Dimethicone/IPDI | | | | |
| | | | | Copolymer | | | | |
| 21 | Silicone | KF889s | 5 | Amodimethicone | 47.62% | 0.28 | 0.06 | NS |
| 22 | Modified | Silsoft 875 | 5 | PEG-12 | 27.70% | 0.14 | 0.26 | NS |
| | silicone | (Momentive) | | Dimethicone | | | | |
| 23 | Synthetic | Flexithix | 5 | PVP | −167.22% | −0.43 | 0.04 | S |
| | polymer | (Ashland Inc.) | | | | | | |
| 24 | Hydrophilic film | Polyolpre- | 15 | PEG-8/SMDI | 50.29% | 0.30 | 0.08 | NS |
| | former | polymer-15 | | Copolymer | | | | |
| | | (Barnet) | | | | | | |
| 25 | Synthetic | Pemulen TR-2 | 0.2 | C10-30 Alkyl | −8.93% | −0.04 | 0.43 | NS |
| | polymer | (Lubrizol) | | Acrylate | | | | |
| | | | | Crosspolymer | | | | |

*Con. Wt. % = Concentration of Compound in 5% glycerin and QS water, by total weight of solution, percent (unless otherwise noted)
⁺Carriers for the agent

Attachment Against DNA Viruses

Testing was also conducted of various compositions against DNA viruses using the High Throughput Test to Quantify the Attachment of Phage to a Surface Test Method as described herein. As noted above, compositions including the agents of water soluble or dispersible polyester (e.g., Polyester-5), Methylcellulose, or Polyvinylpyrrolidone provided anti-adherent properties for DNA viruses. Specifically, the composition including Polyester-5 provided a logarithmic reduction of 1.89, the composition including Methylcellulose provided a logarithmic reduction of 1.03, and the composition including Polyvinylpyrrolidone provided a logarithmic reduction of 1.15, as shown in Table 2 below.

The DNA virus that the compositions were tested against for attachment behaviors was Phi X 174. Bacteriophage are commonly utilized as surrogates of mammalian viruses in both medical and virology applications. Phi X174 is commonly utilized as a viral surrogate because of its size, morphology, environmental stability, and non-human infectivity, and the ability for use in high throughput assays. Phi X174 has been previously been used to study barrier efficacy, making it an ideal surrogate to study attachment to a surface (See, Hamann and Nelson, Am J Infect Control, 1993, 21:289-96, O'Connell, et al, Clin Microb Infect, 2004, 10:322-6, ASTM F1671/F1671M-13, Standard Test Method for Resistance of Materials Used in Protective Clothing to Penetration by Blood—Borne Pathogens Using Phi X174 Bacteriophage Penetration as a Test System). Thus, it is well accepted by those of ordinary skill in the art that Phi X 174 serves as a surrogate for other DNA viruses, and the compositions including the adherent agents noted above would act in a substantially similar behavior to other DNA viruses as they did against Phi X 174.

TABLE 2
Compounds and corresponding Log Reduction of RNA virus using the High
Throughput Test to Quantify the Attachment of Phage to a Surface

| | | | | | | Log R | | |
|---|---|---|---|---|---|---|---|---|
| | | | | | | (PFU/mL) | | |
| | | Compound | Con. | | | compared | | Statistical |
| | Compound | Name | Wt. | | Percent | to growth | T-Test | Signif. |
| # | Type | (Manufacturer) | %* | INCI Name | Reduction | controls | Value | e(p < 0.05) |
| 1 | Modified | Sigma HPMC | 3 | Hydroxypropyl | 85.06% | 0.83 | 0 | S |
| | cellulose | (Sigma Aldrich) | | methylcellulose | | | | |
| 2 | Modified | Benecel A4c | 1 | Methylcellulose | 90.70% | 1.03 | 0 | S |
| | cellulose | (Ashland Inc.) | | | | | | |
| 3 | Modified | Benecel E15 | 1 | Hydroxypropyl- | 91.22% | 1.06 | 0 | S |
| | cellulose | (Ashland Inc.) | | cellulose | | | | |
| 4 | Modified | Natrosol LR | 1 | Hydroxyethyl- | 97.41% | 1.59 | 0 | S |
| | cellulose | (Ashland Inc.) | | cellulose | | | | |
| 5 | Polysaccharide | Structure Cel | 3 | Methyl | −162.21% | −0.42 | 0 | S |
| | | 8000 | | Hydroxyethyl | | | | |
| | | (AkzoNobel) | | Cellulose (MHEC) | | | | |
| 6 | Polysaccharide | Structure Cel | 1.5 | C₁₂₋₁₆ Alkyl PEG-2 | 48.84% | 0.29 | 0 | S |
| | | 500 | | Hydroxypropyl | | | | |
| | | (AkzoNobel) | | Hydroxyethyl | | | | |
| | | | | Ethylcellulose | | | | |
| 7 | Polymeric | Aristoflex Velvet | 0.4 | Polyacrylate | 50.37% | 0.3 | 0.01 | S |
| | sulfonic acid, | (Clariant) | | Crosspolymer-11 | | | | |
| | neutralized | | | | | | | |
| 8 | Hydrophobically | Aculyn 22 | 2 | Acrylates/Steareth- | 94.14% | 1.23 | 0 | S |
| | modified | (Dow Chemicals) | | 20 Methacrylate | | | | |
| | acrylate | | | Copolymer | | | | |
| 9 | Synthetic | Eastman AQ | 5 | Polyester-5 | 98.72% | 1.89 | 0 | S |
| | polymer | (Eastman | | | | | | |
| | | Chemical Co.) | | | | | | |
| 10 | Synthetic | Pluronic 62 | 5 | Ethylene | 96.57% | 1.46 | 0 | S |
| | polymer | (BASF | | Oxide/Propylene | | | | |
| | | Corporation) | | Oxide Block | | | | |
| | | | | Copolymer | | | | |
| 11 | Modified | Arlasilk PLN | 5 | Linoleamidopropyl | 84.51% | 0.81 | 0 | S |
| | silicone | (Croda, Inc.) | | PG-Dimonium | | | | |
| | | | | Chloride | | | | |
| | | | | Phosphate | | | | |
| | | | | Dimethicone | | | | |
| 12 | Hydrophobically | Aculyn 38 | 2 | Acrylates/Vinyl | 75.38% | 0.61 | 0 | S |
| | modified | (Dow Chemicals) | | Neodecanoate | | | | |
| | acrylate | | | Crosspolymer | | | | |
| 13 | anionic | SESAFLASH | 5 | Glycerin⁺, | 89.07% | 0.96 | 0 | S |
| | polymeric | (Seppic) | | Acrylates | | | | |
| | emulsifier | | | Copolymer, | | | | |
| | | | | VP/Polycarbamyl | | | | |
| | | | | Polyglycol Ester, | | | | |
| | | | | Hydrolyzed | | | | |
| | | | | Sesame Protein | | | | |
| | | | | PG-Propyl | | | | |
| | | | | Methylsilanediol⁺ | | | | |
| 14 | Synthetic | Pecogel GC-310 | 5 | VP/Dimethylamino | −32.41% | −0.12 | 0.11 | NS |
| | polymer | (Phoenix | | ethylmethacrylate/ | | | | |
| | | Chemicals) | | Polycarbamyl | | | | |
| | | | | Polyglycol Ester | | | | |
| 15 | Silicone | DC 193 Fluid | 6 | PEG-12 | 97.90% | 1.68 | 0 | S |
| | | (Dow Chemicals) | | Dimethicone | | | | |
| 16 | Synthetic | Sepimax ZEN | 0.4 | Polyacrylate | 70.51% | 0.53 | 0 | S |
| | polymer | (Fairfield) | | Crosspolymer-6 | | | | |
| 17 | Synthetic | Ultrez 10 | 0.4 | Carbomer | 74.08% | 0.59 | 0 | S |
| | polymer | (Lubrizol | | | | | | |
| | | Corporation) | | | | | | |
| 18 | Silicone | Dow Corning | 100 | Dimethicone | 78.79% | 0.67 | 0 | S |
| | | 200 (100 cst) | | | | | | |
| | | (Dow Corning) | | | | | | |
| 19 | Polysaccharide | Protanal Ester | 4 | Propylene Glycol | 94.43% | 1.25 | 0 | S |
| | | BV 3750 | | Alginate | | | | |
| 20 | Modified | Polyderm PPI- | 5 | Bis-PEG-15 | 97.64% | 1.63 | 0 | S |
| | silicone | SI-WS (Alzo) | | Dimethicone/IPDI | | | | |
| | | | | Copolymer | | | | |
| 21 | Silicone | KF889s | 5 | Amodimethicone | 97.97% | 1.69 | 0 | S |
| 22 | Modified | Silsoft 875 | 5 | PEG-12 | 95.17% | 1.32 | 0 | S |
| | silicone | (Momentive) | | Dimethicone | | | | |
| 23 | Synthetic | Flexithix | 5 | PVP | 92.85% | 1.15 | 0 | S |
| | polymer | (Ashland Inc.) | | | | | | |
| 24 | Hydrophilic film | Polyolpre- | 15 | PEG-8/SMDI | 99.43% | 2.24 | 0 | S |
| | former | polymer-15 | | Copolymer | | | | |
| | | (Barnet) | | | | | | |
| 25 | Synthetic | Pemulen TR-2 | 0.2 | C10-30 Alkyl | 83.27% | 0.78 | 0 | S |
| | polymer | (Lubrizol) | | Acrylate | | | | |
| | | | | Crosspolymer | | | | |

*Con. Wt. % = Concentration of Compound in 5% glycerin and QS water, by total weight of solution, percent (unless otherwise noted)
⁺Carriers for the agent

Attachment Against Bacteria

Of the agents tested against DNA and RNA viruses, almost all of the same agents were also tested in compositions against bacteria using either a High Throughput Attachment Test (results shown in Tables 3, 5, and 6) or a Viable Count Attachment Test (results shown in Table 4). The High Throughput Attachment Test and the Viable Count Attachment Test are discussed in further detail below. Unless noted to the contrary, the agents were tested against Gram-positive Staphylococcus aureus, and Gram-negative Escherichia coli. The pH of the compositions for this testing between 3 to 10 pH, or about 4 to about 8 pH.

TABLE 3
Compounds and corresponding Log Reduction of E. coli and
S. aureus using the High Throughput Attachment Test Method.

| | | | Average | Average |
|---|---|---|---|---|
| | Con. | | Log reduction | Log reduction |
| | Wt. | | E. coli | S. aureus |
| Compound | %* | INCI Name | ATCC** 11229 | ATCC** 6538 |
| ACULYN 22 | 2 | Acrylates/Steareth-20 | 1.3 | 1.6 |
| | | Methacrylate Copolymer | | |
| ARISTOFLEX VELVET | 0.40 | Polyacrylate Crosspolymer-11 | 2.6 | 2.1 |
| HPMC | 3 | Hydroxypropyl methylcellulose | 2.6 | 2.5 |
| PECOGEL GC-310 | 5 | VP/Dimethylaminoethylmethacrylate/ | 1.3 | 1.8 |
| | | Polycarbamyl Polyglycol Ester | | |
| POLYOL- | 10 | PEG-8 SMDI Copolymer | 1.2 | 1.4 |
| PREPOLYMER 15 | | | | |
| SESAFLASH | 5 | Glycerin⁺, Acrylates | 1.1 | 1.0 |
| | | Copolymer, VP/Polycarbamyl | | |
| | | Polyglycol Ester, Hydrolyzed | | |
| | | Sesame Protein PG-Propyl | | |
| | | Methylsilanediol⁺ | | |
| Dow Corning 200 | 100 | Dimethicone | Not tested | 1.8 |
| (100 cst) | | | | |

*Con. Wt. % = Concentration of Compound in 5% glycerin and QS water, by total weight of solution, percent (unless otherwise noted)
**“ATCC” is the acronym for the American Type Culture Collection, Manassas, VA
⁺Carriers for the agents

TABLE 4
Compounds and corresponding Log Reduction of E. coli and S. aureus using the Viable Count
Attachment Test Method. Unless specified, the final pH of the agents was between 5 and 7.5.

| | | | Average | Average |
|---|---|---|---|---|
| | Con. | | Log reduction | Log reduction |
| | Wt. | | E. coli | S. aureus |
| Compound | %* | INCI | ATCC** 11229 | ATCC** 6538 |
| ACULYN 38 | 1 | Acrylates/Vinyl Neodecanoate | 0.74 | Not tested |
| | | Crosspolymer | | |
| ACULYN 38⁺⁺ | 1 | Acrylates/Vinyl Neodecanoate | 0.62 | 0.67 |
| | | Crosspolymer | | |
| BENECEL A4C | 1 | Methylcellulose | 1.39 | 1.08 |
| BENECEL E-15 | 1 | Hydroxypropyl Methylcellulose | 2.34 | 1.58 |
| NATROSOL 250 LR | 1 | Hydroxyethylcellulose | 1.00 | 1.13 |
| PROTANAL ESTER BV- | 4 | Propylene Glycol Alginate | 0.76 | 0.70 |
| 3750 | | | | |
| POLYDERM PPI-SI-WS | 5 | Bis-PEG-15 Dimethicone/IPDI | 0.51 | 1.09 |
| | | Copolymer | | |
| EASTMAN AQ 38 | 5 | Polyester-5 | 0.90 | 0.71 |
| FLEXITHIX | 5 | PVP | 0.61 | 0.59 |
| PLURONIC L 62 | 5 | Ethylene Oxide/Propylene | 1.86 | 1.72 |
| | | Oxide Block Copolymer | | |
| SILSOFT 875 | 5 | PEG-12 Dimethicone | 0.55 | 1.46 |
| SEPIMAX ZEN⁺⁺ | 0.4 | Polyacrylate Crosspolymer-6 | 0.51 | 0.70 |
| ARLASILK PLN | 5 | Linoleamidopropyl PG- | 1.08 | 0.87 |
| | | Dimonium Chloride Phosphate | | |
| | | Dimethicone | | |

*Con. Wt. % = Concentration of Compound in 5% glycerin and QS water, by total weight of solution, percent (unless otherwise noted)
**“ATCC” is the acronym for the American Type Culture Collection, Manassas, VA
⁺⁺Provided with 60% ethanol, 5% glycerin (by total weight of the composition), QS water

Tables 5 and 6 provide additional attachment testing against bacteria. Table 5 provides the results of the attachment of Gram negative Escherichia coli to a polystyrene surface treated with various compositions including different compounds according to the High Throughput Attachment Test. Table 6 provides the results of the attachment of Gram positive Staphylococcus aureus to a polystyrene surface treated with various compositions including different compounds according to the High Throughput Attachment Test.

TABLE 5
Compounds and corresponding Log Reduction of
E. coli using the High Throughput Attachment Test

| | | | | | Average Log |
|---|---|---|---|---|---|
| | | Con. | | | reduction |
| Compound | Compound | Wt. | | | E. coli |
| Type | Name | %* | pH | INCI Name | (ATCC** 11229) |
| Polysaccharide | Structure Cel | 1.5 | | Methyl Hydroxyethyl | −11.4 |
| | 8000 M | | | Cellulose (MHEC) | |
| Silicone | KF 889s | 5.0 | | Amodimethicone | −8.4 |
| Synthetic | Ultrez 10 | 5.0 | 4.4 | Carbomer | −5.8 |
| polymer | | | | | |
| Polysaccharide | Structure Cel 500 | 3.0 | | C₁₂₋₁₆ Alkyl PEG-2 | −4.2 |
| | HM | | | Hydroxypropyl Hydroxyethyl | |
| | | | | Ethylcellulose | |
| Synthetic | Pemulen TR-2 | 0.2 | 3.39 | C₁₀₋₃₀ Alkyl Acrylate | −1.0 |
| Polymer | | | | Crosspolymer | |
| Synthetic | Pemulen TR-2 | 0.2 | 6.30 | C₁₀₋₃₀ Alkyl Acrylate | −0.9 |
| Polymer | | | | Crosspolymer | |
| Synthetic | Pemulen TR-2 | 0.2 | | C₁₀₋₃₀ Alkyl Acrylate | −0.3 |
| Polymer | Neutralized | | | Crosspolymer | |
| Silicone | DC 193 | 5.0 | | PEG-12 Dimethicone | 0.6 |
| Polysaccharide | HPMC | 3.0 | | Hydroxy Propyl Methyl | 2.5 |
| | | | | Cellulose | |

*Con. Wt. % = Concentration of Compound in 5% glycerin and QS water, by total weight of solution, percent (unless otherwise noted)
**“ATCC” is the acronym for the American Type Culture Collection, Manassas, VA

TABLE 6
Compounds and corresponding Log Reduction of Staphylococcus aureus
using the High Throughput Attachment Test

| | | | | | Average Log |
|---|---|---|---|---|---|
| | | | | | reduction |
| | | Con. | | | S. aureus |
| Compound | Compound | Wt. | | | (ATCC** |
| Type | Name | %* | pH | INCI Name | 6538) |
| Synthetic | Ultrez 10 | 5.0 | 4.4 | Carbomer | −5.8 |
| polymer | | | | | |
| Synthetic | Pemulen TR-2 | 0.2 | 6.3 | C₁₀₋₃₀ Alkyl | −3.2 |
| polymer | | | | Acrylate | |
| | | | | Crosspolymer | |
| Synthetic | Pemulen TR-2 | 0.2 | 7.3 | C₁₀₋₃₀ Alkyl | −0.9 |
| Polymer | | | | Acrylate | |
| | | | | Crosspolymer | |
| Synthetic | Pemulen TR-2 | 0.2 | 5.4 | C₁₀₋₃₀ Alkyl | −0.4 |
| Polymer | | | | Acrylate | |
| | | | | Crosspolymer | |
| Synthetic | Pemulen TR-2 | 0.2 | | C₁₀₋₃₀ Alkyl | −0.1 |
| Polymer | Neutralized | | | Acrylate | |
| | | | | Crosspolymer | |

*Con. Wt. % = Concentration of Compound in 5% glycerin and QS water, by total weight of solution, percent (unless otherwise noted)
**“ATCC” is the acronym for the American Type Culture Collection, Manassas, VA

### Test Methods

### High Throughput Test to Quantify the Attachment of Phage to a Surface

1.0 Test Methods:
Growth and purification of phage is outlined in the following steps.
   1.1 Subculture: (these steps ensured that the organism are less than 5 generations removed from the original clinical isolate):
      1.1.1 Using a cryogenic stock (at −70° C.), a first sub-culture of the bacterial organisms listed above is streaked out on appropriate media.
      1.1.2 The plate is incubated at 36±2° C. for 24 hours and store the plate is wrapped in parafilm at 4° C.
      1.1.3 From the first sub-culture, a second sub-culture is streaked out on appropriate media. It is incubated at 36±2° C. for 24 hours. The second sub-culture is used within 24 hours starting from the time it is first removed from incubation.
      1.1.4 Organism(s) from the second sub-culture are inoculated into 30-200 mL OSB and incubated at 36±2° C. on a rotary shaker (at approximately 150 rpm) for 16-18 hours. This is to achieve an inoculum density of approximately 10⁹ CFU/ml.
   1.2 Prepare Top Agar:
      1.2.1 Top Agar is prepared by preparing 200 mL of OSB according to manufacturer's directions and adding 0.7% agar. After sterilization, the sterilized mix is stored in a water bath set at 49° C.
      1.2.2 The top agar solution is aliquoted by moving 4 mL into sterile tubes. The tubes are kept at 49 C until needed for use.
   1.3 Preparation of bacterial host:
      1.3.1 40 mL of broth culture is moved to a centrifuge tube.
      1.3.2 The overnight broth culture is centrifuged at 4000×g for 5 minutes.
      1.3.3 The supernatant is decanted and the cells were re-suspended in the same volume (40 mL for example) of BPB.
      1.3.4 Steps 4.2.2 to 4.2.3 are repeated one more time.
   1.4 Propagation of the Phage:
      1.4.1 The OSA plates to be used are warmed to room temperature.
      1.4.2 The top agar tubes are inoculated with 200 μL of concentrated phage stock from either an ATCC or a previously stored concentrated stock. For frozen stock 500 μL of TSB warmed to 49° C. is added before adding to the Top Agar.
      1.4.3 100 μL of the washed broth culture is added and swirled gently to mix.
      1.4.4 Each inoculated top agar tube is poured onto one prepared OSA plate. The plate is tilted to ensure that the top agar was spread across the entire surface.
      1.4.5 The top agar is allowed to solidify, was inverted and placed in an incubator at 37° C. for overnight growth.
      1.4.6 Following overnight growth the plates should show complete clearing.
      1.4.7 The SM Buffer solution is warmed to 49° C.
      1.4.8 2 mL of warmed SM Buffer is added to each plate and the top agar is scraped using sterile white Teflon policeman. A pipette is used to transfer all the SM buffer and top agar to a sterile tube. This is done for every plate.
      1.4.9 The collected top agar tubes are vortexed for 10-15 seconds.
      1.4.10 The vortexed tubes are centrifuged at 1000×g for 25 minutes.
      1.4.11 From each centrifuged tube the supernatants are pooled in one new sterile tube.
      1.4.12 A sterile 0.20 filter is prepared by flushing 2-3 mL of 3% w/v cold (4 C) beef extract through the filter and discarded.
      1.4.13 The prepared filter is used to filter the pooled recovered top agar into a fresh sterile tube.
      1.4.14 The collected filtrate is the purified phage. Plaque Forming Units (PFU) are checked by serially diluting and spot plating using the method described in section 4.5.
   1.5 Phage (MS2 and PhiX 174) Enumeration:
      1.5.1 Phage is prepared for use from the stock by diluting 1:1 in BPB.
      1.5.2 Spot Plate Method:
         1.5.2.1 A cell dilution of ˜10⁶ CFU/mL of E. coli (E. coli K12 is used for MS2 phage and E. coli C is used for PhiX 174) is prepared from the prepared washed broth culture by diluting in sterile BPB.
         1.5.2.2 An inoculum check is performed on the bacterial dilution in triplicate.
         1.5.2.3 In a 96 well plate, columns 1-12 are filled with 180 μL of the 10⁶ CFU/ml E. coli suspension in BPB
         1.5.2.4 20 μL of the samples to be diluted is added in column 1.
         1.5.2.5 10-fold (10× Dilution) in BPB is performed from 10¹-10¹² by moving 20 μL from column 1 to column 2 and mixing. This is repeated, moving down the columns until column 12.
         1.5.2.6 20 μL (or 10 if agar permits) is spot plated on a large labelled OSA plate (spot plate every second column to avoid cross merging of spot plated phages.
         1.5.2.7 Plates are inverted & incubated for 24 h at 37° C.
         1.5.2.8 After 24 h the number of PFU is counted.
   1.6 Preparation of the Challenge plates:

TABLE 7
The challenge will be tested using the specified
contact time (Total of 6 challenge plates). SC
wells are sterility controls for each experiment.

| | | | | | | | | | | | |
|---|---|---|---|---|---|---|---|---|---|---|---|
| 1 | 2 | 3 | 4 | 5 | 6 | 7 | 8 | 9 | 10 | 11 | 12 |

| | | | | | | | | | |
|---|---|---|---|---|---|---|---|---|---|
| A | A | B | C | D | E | F | SC-A | GC | GC |
| B | A | B | C | D | E | F | SC-B | GC | GC |
| C | A | B | C | D | E | F | SC-C | GC | GC |
| D | A | B | C | D | E | F | SC-D | GC | GC |
| E | A | B | C | D | E | F | SC-E | GC | GC |
| F | A | B | C | D | E | F | SC-F | GC | GC |
| G | A | B | C | D | E | F | | GC | GC |
| H | A | B | C | D | E | F | | GC | GC |

1.6.1 Preparation of compounds and coating compounds onto MBEC plate lid
1.6.2 Using a positive displacement pipette aseptically add 200 μL of compounds to be tested to a sterile 96-well microplate according to the plate layout described below.
1.6.3 Add 200 μL of each code to the appropriate well for sterility controls.
1.6.4 Place the MBEC plate lid, peg side down into the 96-well microplate containing the test compound solutions.
1.6.5 Allow the plate to sit at room temperature (25±3° C.) for 2 hrs.
1.6.6 Remove the MBEC plate lid and allow the lid to dry at room temperature (25±3° C.) overnight in a laminar flow hood by spacing the MBEC plate lid from the MBEC plate trough with two 10 μL disposable loops.
1.7 Phage attachment to MBEC Lids:
   1.7.1 Using the phage prepared in 1:1 BPB from stock 100 μL is added to the wells indicated by the plate layout of the sterile 96 well plate.
   1.7.2 The sterile MBEC lid is placed into the wells.
   1.7.3 The plate is allowed to incubate for 1 hour at room temperature without shaking.
   1.7.4 Rinse plates, 3 plates per MBEC lid, by adding 200 μL of PBS to wells indicated by the plate layout of a sterile 96 well plate.
1.8 Phage recovery:
   1.8.1 Using flamed pliers the pegs are removed from the MBEC lid and placed in a tube containing 5 mL BPB.
   1.8.2 Vortex for 1 minute.
   1.8.3 Perform a serial dilution on the recovery solution.
   1.8.4 Enumerate the PFU by using one of the methods indicated previously.
1.9 LOG₁₀ Reduction:
   1.9.1 In a 96 well plate, columns 1-12 are filled with 180 μL of the 10E6 CFU/ml of the appropriate E. coli suspension in BPB
   1.9.2 20 μL of the samples to be diluted is added in column 1.
   1.9.3 10-fold (10× Dilution) in BPB is performed from 10E1-10e12 by moving 20 μL from column 1 to column 2 and mixing. This is repeated, moving down the columns until column 12.
   1.9.4 20 μL (or 10 if agar permits) is spot plated on a large labelled OSA plate (spot plate every second column to avoid cross merging of spot plated phages.
   1.9.5 Plates are inverted & incubated for 24 h at 37° C.
   1.9.6 After 24 h the number of PFU is counted.
   1.9.7 Cell Enumeration:
      1.9.7.1 Count the appropriate number of colonies according to the plating method used.
      1.9.7.2 Calculate the arithmetic mean of the colonies counted on the plates.
The log density for one peg is calculated as follows:

LOG₁₀(PFU/peg)=LOG₁₀[(X/B)(D)] where:
X=mean PFU,
B=volume plated (0.02 mL)
and D=dilution.
Calculate the overall attached bacteria accumulation by calculating the mean of the log densities calculated.
Calculate the LOG 10 reduction for each dilution as follows: LOG₁₀ Reduction=Mean LOG₁₀ Growth Control−Mean LOG₁₀ Test.
Calculate the Percent Reduction by calculating (Log₁₀ (PFU/Peg) of the growth control pegs-Log₁₀ (PFU/Peg) of the treated pegs)/Log₁₀ (PFU/Peg) of the growth control pegs)×100
   1.10 Accept or reject criteria
      1.10.1 Growth controls for the phage are between 4 and 6 Log 10
      1.10.2 Sterility controls do not show any growth.

### High Throughput Attachment Test Method

This test method specifies the operational parameters required to grow and or prevent the formation of bacterial attachment using a high throughput screening assay. The assay device consists of a plastic lid with ninety-six (96) pegs and a corresponding receiver plate with ninety-six (96) individual wells that have a maximum 200 μL working volume. Biofilm is established on the pegs under static batch conditions (i.e., no flow of nutrients into or out of an individual well).
1. Terminology
   1.2 Definitions of Terms Specific to This Standard:
   1.2.2 peg, n—biofilm sample surface (base: 5.0 mm, height: 13.1 mm).
   1.2.3 peg lid, n—an 86×128 mm plastic surface consisting of ninety-six (96) identical pegs.
   1.2.4 plate, n—an 86×128 mm standard plate consisting of ninety-six (96) identical wells.
   1.2.5 well, n—small reservoir with a 50 to 200 μL working volume capacity.
2. Acronyms
   2.2 ATCC: American Type Culture Collection
   2.3 CFU: colony forming unit
   2.4 rpm: revolutions per minute
   2.5 SC: sterility control
   2.6 TSA: tryptic soy agar
   2.7 TSB: tryptic soy broth
   2.8 GC: growth control
3. Apparatus
   3.2 Inoculating loop—nichrome wire or disposable plastic.
   3.3 Petri dish—large labelled (100×150×15 mm, plastic, sterile) for plating.
   3.4 Microcentrifuge tubes—sterile, any with a 1.5 mL volume capacity.
   3.5 96-well microtiter plate—sterile, 86×128 mm standard plate consisting of ninety-six (96) identical flat bottom wells with a 200 μL working volume
   3.6 Vortex—any vortex that will ensure proper agitation and mixing of microfuge tubes.
   3.7 Pipette—continuously adjustable pipette with volume capability of 1 mL.
   3.8 Micropipette—continuously adjustable pipette with working volume of 10 μL-200 μL.
   3.9 Sterile pipette tips-200 uL and 1000 uL volumes.
   3.10 Sterile reagent reservoir-50 mL polystyrene.
   3.11 Sterilizer—any steam sterilizer capable of producing the conditions of sterilization.
   3.12 Colony counter—any one of several types may be used. A hand tally for the recording of the bacterial count is recommended if manual counting is done.
   3.13 Environmental incubator—capable of maintaining a temperature of 35±2° C. and relative humidity between 35 and 85%.
   3.14 Reactor components—the MBEC Assay device available from Innovotech, Edmonton, AB, Canada.
   3.15 Sterile conical tubes—50 mL, used to prepare initial inoculum.
   3.16 Appropriate glassware—as required to make media and agar plates.
   3.17 Erlenmeyer flask—used for growing broth inoculum.
   3.18 Positive Displacement pipettes capable of pipetting 200 μL.
   3.19 Sterile pipette tips appropriate for Positive Displacement pipettes.
4. Reagents and Materials
   4.2 Purity of water—all references to water as diluent or reagent shall mean distilled water or water of equal purity.
   4.3 Culture media:
   4.4 Bacterial growth broth—Tryptic soy broth (TSB) prepared according to manufacturer's directions.
   4.5 Bacterial plating medium—Tryptic soy agar (TSA) prepared according to manufacturer's directions.
   4.6 Phosphate Buffered Saline (PBS)—
   4.7 Rinse Solution: Sterile PBS and TWEEN 80 (Sigma-Aldrich, St. Louis, Mo.) 1% w/v.
5. MICROORGANISMS:
   5.1 E. coli ATCC 11229 and S. aureus ATCC 6538
6. TEST METHOD overview: The experimental process for the High-Throughput Anti-Adherence Test Method. This standard protocol may be broken into a series of small steps, each of which is detailed in the sections below.
   6.1 Culture Preparation
   6.1.1 E. coli ATCC 11229 and S. aureus ATCC 6538 are the organisms used in this test.
   6.1.2 Using a cryogenic stock (at −70° C.), streak out a subculture of the above listed microorganisms on organism's specific agar (TSA).
   6.1.3 Incubate at 35±2° C. for the period of time of 22±2 hours.
   6.1.4 Aseptically remove isolated colony from streak plate and inoculate 20 mL of sterile TSB.
   6.1.5 Incubate flask at 35±2° C. and 175±10 rpm for 16 to 18 hours (E. coli and S. aureus). Viable bacterial density should be 10⁹ CFU/mL and should be checked by serial dilution and plating.
   6.1.6 Pipette 10 mL from the incubation flask of E. coli and S. aureus into a 50 mL conical tube and spin down at 5 minutes at 4,000×g. Then remove supernatant and Resuspend in 10 mL sterile PBS. Approximate cell density should be 10⁷-10⁹ CFU/mL. Vortex the sample for approximately 30 seconds to achieve a homogeneous distribution of cells.
   6.1.7 Perform 10-fold serial dilutions of the inoculum in triplicate.
   6.1.8 Plate appropriate dilutions on appropriately labelled TSA plates. Incubate the plates at 35±2° C. for 22±2 hours depending on the isolates growth rate and enumerate.
6.2 Preparation of the Challenge plates:
   6.2.1 Preparation of compounds and coating compounds onto MBEC plate lid
   6.2.1.1.1 Using a positive displacement pipette aseptically add 200 μL of compounds and control to be tested to a sterile 96-well microplate according to the plate layout of Table 4.
   6.2.1.1.2 Add 200 μL of each code to the appropriate well for sterility controls.
   6.2.1.1.3 Place the MBEC plate lid, peg side down into the 96-well microplate containing the test compound solutions.
   6.2.1.1.4 Allow the plate to sit at room temperature (25±3° C.) for 2 hours.
   6.2.1.1.5 Remove the MBEC plate lid and allow the lid to dry at room temperature (25±3° C.) overnight in a laminar flow hood.
7.1 Bacterial Adherence Challenge:
   7.1.1 Add 100 μL of diluted bacteria to the appropriate wells in a sterile 96-well microplate as indicated in the plate layout in Table 4.
   7.1.2 Add 200 μL of sterile PBS to the sterility controls.
   7.1.3 The MBEC containing dried compounds is then inserted into the bacterial inoculated 96 well flat bottom microplate from section 9.3.1
   7.1.4 Incubate stationary at room temperature (25±3° C.) for 15 minutes.
   7.1.5 Remove the MBEC lid and place into a 96-well microplate containing 200 μL PBS+1% w/v TWEEN 80. Incubate stationary at room temperature (25±3° C.) for 15 seconds.
   7.1.6 Repeat step 7.1.5 for two additional washes for a total of 3 washes.
7.2 Method to Determine Number of Attached Bacteria
   7.2.1 Transfer the washed MBEC plate lid to a 96-well plate containing 200 μL ALAMARBLUE reagent (prepared according to manufacturer's directions, Life Technologies, Carlsbad, Calif.) in each well to be tested.
   7.2.2 The final plate is transferred to a SPECTRAMAX GEMINI EM microplate reader (Molecular Devices, Inc. Sunnyvale, Calif. USA) for a 20 hour kinetic, bottom read with an excitation of 560 nm and emission of 590 nm. The rate of fluorescence development (relative fluorescence units (RFU)/minute) is determined for each well.
   7.2.3 Data was analyzed using a standard curve (described below) for each organism to determine the numbers of bacteria attached to the pegs (Log CFU/mL) present in each sample. Number of attached bacteria was quantified by incubating with an ALAMARBLUE reagent and measuring fluorescence development over time.
   7.2.4 From these data, the Log CFU/mL reduction of each time point relative to the growth control is calculated to determine the activity of each code.
7.3 Method for Generating a Standard Curve with bacteria in an ALAMARBLUE Solution:
   7.3.1 Standard curves were constructed for each organism to define the rate of fluorescence development as a function of bacterial concentration, as determined via viable plate counts. This standard curve provided the ability to relate rate of fluorescence development (RFU/minute) to the Log CFU/mL number of bacteria present in a given sample
   7.3.2 Day 1:
   7.3.2.1 Aseptically remove loopful of bacteria strain to be tested from freezer stock and place in 20 mL of TSB media in a culture flask.
   7.3.2.2 Incubate with shaking (200 rpm) for 22±2 hours at 37±2° C.
   7.3.3 Day 2:
   7.3.3.1 Aseptically transfer 100 μL of the 22±2 hours freezer stock cultures into 20 mL of TSB media in a culture flask.
   7.3.3.2 Incubate cultures on a gyrorotary shaker (200 rpm) for 22±2 hours at 37±2° C.
   7.3.3.3 Perform a streak for isolation from the culture flask on TSA. Incubate plate for 22±2 hours at 37±2° C.
   7.3.4 Day 3:
   7.3.4.1 Prepare an ALAMARBLUE solution according to the manufacturer's directions.
   7.3.4.2 Remove culture flask from shaking incubator after 22±2 hours. Pipette 1 mL of bacteria into a 1.7 mL microcentrifuge tube.
   7.3.4.3 Centrifuge the bacteria at 4000×g.
   7.3.4.4 Resuspend bacterial cells in sterile PBS. Perform a total of two washes.
   7.3.4.5 Perform 1:10 serial dilutions with washed bacterial culture in 0.9 mL dilution blanks of sterile PBS (100 μL culture into 900 μL of sterile PBS).
   7.3.4.6 Plate appropriate dilutions of prepared bacteria.
   7.3.4.7 Add 270 μL of ALAMARBLUE solution to wells A-D: columns 1-7 of a 96-well plate.
   7.3.4.8 Add 30 μL of bacterial dilution the wells of a 96-well plate (n=4 per dilution).
   7.3.4.9 Add 30 μL of sterile PBS to wells A-D, column 8 for a background control.
   7.3.4.10 Place plate in a bottom reading spectrophotometer that measures fluorescence. Set temp to 37° C. Perform assay at 37° C., read every 20 minutes for 24 hours at 560 excite and 590 emit.
   7.3.4.11 Enumerate the dilutions.
   7.3.4.12 Calculate the mean rate of fluorescence development.
   7.3.4.13 Plot the mean rate of fluorescence development as a function of the mean CFU/mL of the dilutions.

### Viable Count Attachment Test Method

This test method specifies the operational parameters required to grow and or prevent the formation of bacterial attachment using viable counts. The assay device consists of a plastic lid with ninety-six (96) pegs and a corresponding receiver plate with ninety-six (96) individual wells that have a maximum 200 μL working volume. Biofilm is established on the pegs under static batch conditions (i.e., no flow of nutrients into or out of an individual well).

This test method is identical to the High Throughput Attachment Test Method except that Section 7.1 through 7.3.4.13 is replaced with the following:

A. Bacterial Adherence Challenge:
A.1 Add 100 μL of diluted bacteria to the appropriate wells in a sterile 96-well microplate as indicated in the plate layout in Table 4.
A.2 Add 200 μL of sterile PBS to the sterility controls.
A.3 The MBEC containing dried compounds is then inserted into the bacterial inoculated 96 well flat bottom microplate from section 9.3.1

B. Recovery:
B.1 After the 15 minute contact time, transfer the MBEC™ lid to the rinse plate where each well contains 200 μL for 15 seconds of saline and 1% Tween 80 to wash of any loosely attached planktonic cells. Repeat this for 3 separate wash plates.
B.2 S. aureus Recovery:
   B.2.1 Break the corresponding pegs from the MBEC™ lid using a sterile pliers and transfer them into 50 mL conical tubes containing 10 mL PBS.
   B.2.2 Vortex the conical tubes for 10 seconds
   B.2.3 Transfer the conical tubes to the sonicator and sonicate on high. Sonicate for 1 minute on. Then allow the tubes to rest for 1 minute. Repeat the sonication step for a total of 5 minutes of sonication to dislodge surviving attached bacteria. The conical tubes were placed in the sonicator water bath using a float.
   B.2.4 Vortex the conical tubes again for 10 seconds.
B.3 E. coli Recovery:
   B.3.1 Transfer the MBEC™ lid to a plate containing 200 μL PBS.
   B.3.2 Transfer the plate to the sonicator and sonicate on high for 10 minutes to dislodge surviving attached bacteria. The plates are placed in a dry stainless steel insert tray which sits in the water of the sonicator. The vibrations created in the water by the sonicator transfer through the insert tray to actively sonicate the contents of the 96 well recovery plate(s).

C. LOG₁₀ Reduction:
C.1 Following sonication, place 100 μL from each well of the MBEC™ plate, into the first 12 empty wells of the first row of a 96 well-micro titer plate. Place 180 μL of sterile 0.9% saline in the remaining rows.
C.2 Prepare a serial dilution (10⁰-10⁻⁷) by moving 20 μL down each of the 8 rows.
C.3 Remove 10 μL from each well and spot plate on a prepared TSA plates.
C.4 Plates are incubated at 37±1° C. and counted after approximately 24 h hours of incubation.
C.5 Data will be evaluated as Log 10 CFU/peg.
C.6 Cell Enumeration:
C.7 Count the appropriate number of colonies according to the plating method used.
C.8 Calculate the arithmetic mean of the colonies counted on the plates.
   C.8.1 The log density for one peg is calculated as follows:

Log₁₀ (CFU/peg)=Log₁₀ [(X/B)(D)] where:
X=mean CFU; B=volume plated (0.02 mL); and D=dilution.
C.9 Calculate the overall attached bacteria accumulation by calculating the mean of the log densities calculated.
C.10 Calculate the Log₁₀ reduction for each dilution as follows: LOG 10 Reduction=Mean LOG₁₀ Growth Control−Mean Log₁₀ Test.

### Explanation of Log Decrease

The compositions of the present disclosure exhibit a decrease of DNA viruses on surfaces. Log decrease, for example, may be determined from the decrease of DNA viruses adhered to a surface according to the following correlations:

| Fold Decrease of Viruses | LOG Decrease |
|---|---|
| 1 | 0.5 |
| 10 | 1 |
| 100 | 2 |
| 1000 | 3 |

In other words, surface exhibiting a decrease of viruses of 1 Log means the number of viruses on the fibrous substrate has decreased 10-fold, a decrease of 2 Log means the number of viruses has decreased 100-fold, a decrease of 3 Log means the number of viruses has decreased 1000-fold, etc., as compared to the number of bacteria present on a surface that is not treated with the disclosed composition. A larger Log decrease thus corresponds with a composition that is able to more effectively repel viruses.

### Embodiments

Embodiment 1: A composition for increasing the adherence of RNA viruses, the composition comprising: a liquid carrier; an adherent agent selected from the group consisting of: water soluble or dispersible polyester, Methylcellulose, Polyvinylpyrrolidone, and combinations thereof; and a humectant; wherein the composition is non-antimicrobial.
Embodiment 2: The composition of embodiment 1, wherein the humectant is selected from the group consisting of: glycerin, glycerin derivatives, hyaluronic acid derivatives, betaine derivatives amino acids, amino acid derivatives, glycosaminoglycans, glycols, polyols, sugars, sugar alcohols, hydrogenated starch hydrolysates, hydroxy acids, hydroxy acid derivatives, salts of PCA, and any combination thereof.
Embodiment 3: The composition of embodiment 1, wherein the humectant is selected from the group consisting of: honey, sorbitol, hyaluronic acid, sodium hyaluronate, betaine, lactic acid, citric acid, sodium citrate, glycolic acid, sodium glycolate, sodium lactate, urea, propylene glycol, butylene glycol, pentylene glycol, ethoxydiglycol, methyl gluceth-10, methyl gluceth-20, PEG-2, PEG-3, PEG-4, PEG-5, PEG-6, PEG-7, PEG-8, PEG-9, PEG-10, xylitol, maltitol, and any combination thereof.
Embodiment 4: The composition of embodiment 1, wherein the humectant is selected from the group consisting of: glycerin, a glycerin derivative, and combinations thereof.
Embodiment 5: The composition of any one of the preceding embodiments, further comprising an ingredient selected from the group consisting of an emollient, a surfactant, and any combination thereof.
Embodiment 6: The composition of any one of the preceding embodiments, wherein the adherent agent increases the attachment of RNA viruses to a polystyrene surface by at least −0.25 Log of viruses according to the High Throughput Test to Quantify the Attachment of Phage to a Surface as described herein.
Embodiment 7: The composition of any one of the preceding embodiments, wherein the adherent agent increases the attachment of RNA viruses to a polystyrene surface by at least −0.35 Log of bacteria according to the High Throughput Test to Quantify the Attachment of Phage to a Surface as described herein.
Embodiment 8: The composition of any one of the preceding embodiments, wherein the water soluble or dispersible polyester is Polyester-5.
Embodiment 9: The composition of any one of the preceding embodiments, wherein the adherent agent is present in the amount of about 0.01% to about 20.0% by weight of the composition, and wherein the humectant is present in the amount of about 0.01% to about 20.0% by weight of the composition.
Embodiment 10: A method for removing RNA viruses from a surface, the method comprising: providing a composition for increasing the adherence of RNA viruses, the composition comprising: an adherent agent selected from the group consisting of: water soluble or dispersible polyester, Methylcellulose, Polyvinylpyrrolidone, and combinations thereof; the composition being non-antimicrobial; applying the composition to the surface; and removing at least some of the composition from the surface to remove RNA viruses from the surface.
Embodiment 11: The method of embodiment 10, wherein the composition further comprises a liquid carrier and a humectant.
Embodiment 12: The method of embodiment 12, wherein the humectant is selected from the group consisting of: glycerin, glycerin derivatives, hyaluronic acid derivatives, betaine derivatives amino acids, amino acid derivatives, glycosaminoglycans, glycols, polyols, sugars, sugar alcohols, hydrogenated starch hydrolysates, hydroxy acids, hydroxy acid derivatives, salts of PCA, and any combination thereof.
Embodiment 13: The method of any one of embodiments 10-12, wherein the water soluble or dispersible polyester is Polyester-5.
Embodiment 14: The method of any one of embodiments 10-13, further comprising: allowing at least some of the composition to remain on the surface.
Embodiment 15: The method of any one of embodiments 10-14, wherein the composition is applied to the surface in a solution form.
Embodiment 16: The method of any one of embodiments 10-15, wherein the composition is incorporated in a wipe.
Embodiment 17: A wipe comprising: a nonwoven substrate; and a composition for increasing the adherence of RNA viruses comprising: a liquid carrier; and an adherent agent selected from the group consisting of: water soluble or dispersible polyester, Methylcellulose, Polyvinylpyrrolidone, and combinations thereof; the composition being non-antimicrobial.
Embodiment 18: The wipe of embodiment 17, wherein the composition further comprises a humectant.
Embodiment 19: The wipe of embodiment 18, wherein the humectant is selected from the group consisting of: glycerin, glycerin derivatives, hyaluronic acid derivatives, betaine derivatives amino acids, amino acid derivatives, glycosaminoglycans, glycols, polyols, sugars, sugar alcohols, hydrogenated starch hydrolysates, hydroxy acids, hydroxy acid derivatives, salts of PCA, and any combination thereof.
Embodiment 20: The wipe of embodiment 18, wherein the humectant is selected from the group consisting of: glycerin, a glycerin derivative, and combinations thereof.

When introducing elements of the present disclosure, the articles “a”, “an”, “the” and “said” are intended to mean that there are one or more of the elements. The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the disclosure.

1.-9. (canceled)

10. A method for removing RNA viruses from a surface, the method comprising:
providing a composition for increasing the adherence of RNA viruses, the composition comprising:
an adherent agent selected from the group consisting of: water soluble or dispersible polyester, Polyvinylpyrrolidone, and combinations thereof;
the composition being non-antimicrobial;
applying the composition to the surface; and
removing at least some of the composition from the surface to remove RNA viruses from the surface.

11. The method of claim 10, wherein the composition further comprises a liquid carrier and a humectant.

12. The method of claim 11, wherein the humectant is selected from the group consisting of: glycerin, glycerin derivatives, hyaluronic acid derivatives, betaine derivatives amino acids, amino acid derivatives, glycosaminoglycans, glycols, polyols, sugars, sugar alcohols, hydrogenated starch hydrolysates, hydroxy acids, hydroxy acid derivatives, salts of PCA, and any combination thereof.

13. The method of claim 10, wherein the water soluble or dispersible polyester is Polyester-5.

14. The method of claim 10, further comprising:
allowing at least some of the composition to remain on the surface.

15. The method of claim 10, wherein the composition is applied to the surface in a solution form.

16. The method of claim 10, wherein the composition is incorporated in a wipe.

17.-20. (canceled)

21. The method of claim 16, wherein the wipe comprises a nonwoven substrate.

22. The method of claim 10, wherein the adherent agent is Polyester-5.

23. The method of claim 10, wherein the adherent agent is Polyvinylpyrrolidone.

24. The method of claim 10, wherein the adherent agent comprises from about 0.01% to about 20% of the composition by total weight of the composition.

25. The method of claim 10, wherein the surface is an abiotic surface.

26. The method of claim 25, wherein the abiotic surface is selected from the group consisting of: a food prep surface, a hospital and clinic surface, a household surface, an automotive surface, a train surface, a ship surface, and an aircraft surface.

27. A method for removing RNA viruses from an abiotic surface, the method comprising:
providing a composition for increasing the adherence of RNA viruses, the composition comprising:
an adherent agent selected from the group consisting of: water soluble or dispersible polyester, Polyvinylpyrrolidone, and combinations thereof;
the composition being non-antimicrobial;
applying the composition to the abiotic surface; and
removing at least some of the composition from the abiotic surface to remove RNA viruses from the abiotic surface.

28. The method of claim 27, wherein the composition further comprises a liquid carrier and a humectant.

29. The method of claim 28, wherein the humectant is selected from the group consisting of: glycerin, glycerin derivatives, hyaluronic acid derivatives, betaine derivatives amino acids, amino acid derivatives, glycosaminoglycans, glycols, polyols, sugars, sugar alcohols, hydrogenated starch hydrolysates, hydroxy acids, hydroxy acid derivatives, salts of PCA, and any combination thereof.

30. The method of claim 27, wherein the adherent agent is Polyester-5.

31. The method of claim 27, wherein the adherent agent is Polyvinylpyrrolidone.

32. The method of claim 27, wherein the adherent agent comprises from about 0.01% to about 20% of the composition by total weight of the composition.

33. The method of claim 27, wherein the composition is incorporated in a wipe.
